(19) United States
(12) Patent Application Publication
(10) Pub. No.: US 2015/0128060 A1
(43) Pub. Date: May 7, 2015

(54) METHOD AND APPARATUS OF PROVIDING APPLICATION PROGRAM INFORMATION IN MOBILE TERMINAL DEVICE

(71) Applicant: Alibaba Group Holding Limited, Grand Cayman (KY)

(72) Inventors: Jason Xu, Hangzhou (CN); Yu-Jen Huang, Hangzhou (CN); Yihao Hu, Hangzhou (CN); Cai Sun, Hangzhou (CN)

(21) Appl. No.: 14/533,734

(22) Filed: Nov. 5, 2014

(30) Foreign Application Priority Data
Nov. 6, 2013 (CN) 201310547803.4

(51) Int. Cl. G06F 3/0482; H04L 29/08

(52) U.S. Cl. CPC G06F 3/0482; H04L 67/10
USPC 715/739

(57) ABSTRACT

A method and an apparatus for providing application program information in a mobile terminal device are provided. The method includes: providing a first operation entrance for selecting a concerned application program to a user in a user interface; determining the concerned application program based on a selection operation received via the first operation entrance; obtaining information that is pending for display in the concerned application program; and displaying the information that is pending for display in a lock screen interface of the mobile terminal device. Using the present disclosure, the path of acquiring information for a user can be shortened.

### CROSS REFERENCE TO RELATED PATENT APPLICATION

This application claims foreign priority to Chinese Patent Application No. 201310547803.4 filed on Nov. 6, 2013, entitled “Method and Apparatus of Providing Application Program information in Mobile Terminal Device”, which is hereby incorporated by reference in its entirety.

### TECHNICAL FIELD

The present disclosure relates to the field of mobile communication technologies, and in particular, to methods and apparatuses of providing application program information in a mobile terminal device.

### BACKGROUND

Along with the rapid development of mobile terminal devices and mobile communication technologies, intelligent mobile terminals have become the most common means of acquiring various types of information used by users. Currently, a mobile terminal user obtains information in a mobile terminal mainly through an application program (App). The user needs to enter a main interface of the mobile terminal, finds an icon of a desired App from among a plurality of icons, clicks the icon to start the App, and acquires information provided by the App. As can be seen, the path of acquiring information in each time is relatively long. When the number of installed Apps becomes larger, a problem of locating thereof also exists.

Therefore, a technical problem that is urgently needed to be solved by one skilled in the art is how to shorten the path of acquiring information for a user.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides methods and apparatuses of providing application program information in a mobile terminal device, which can shorten a path of acquiring information for a user.

The present disclosure provides the following solution:

A method of providing application program information in a mobile terminal device includes:

providing a first operation entrance for selecting a concerned application program to a user in a user interface;

determining the concerned application program based on a selection operation received via the first operation entrance;

obtaining information that is pending for display in the concerned application program; and

displaying the information that is pending for display in a lock screen interface of the mobile terminal device.

A method for providing application program information includes:

receiving and storing identity information of a concerned application program and identity information of a corresponding mobile terminal device that is uploaded by a client;

obtaining information that is pending for display from at least one second server corresponding to the concerned application program based on the stored identity information of the concerned application program, and storing a correspondence relationship between the information that is pending for display and an identity of the mobile terminal device; and

providing the information that is pending for display to the client of the mobile terminal device based on the stored correspondence relationship.

An apparatus for providing application program information in a mobile terminal device includes:

a first operation entrance provision unit used for providing a first operation entrance for selecting a concerned application program to a user in a user interface;

a concerned application program determination unit used for determining the concerned application program based on a selection operation received via the first operation entrance;

a display-pending information acquisition unit used for obtaining information that is pending for display in the concerned application program; and

a lock screen interface display unit used for displaying the information that is pending for display in a lock screen interface of the mobile terminal device.

An apparatus for providing application program information includes:

an information receiving unit used for receiving and storing identity information of a concerned application program and identity information of a corresponding mobile terminal device that is uploaded by a client;

a display-pending information acquisition unit used for obtaining information that is pending for display from at least one second server corresponding to the concerned application program based on the stored identity information of the concerned application program, and storing a correspondence relationship between the information that is pending for display and an identity of the mobile terminal device; and

a display-pending information provision unit used for providing the information that is pending for display to the client of the mobile terminal device based on the stored correspondence relationship.

According to specific embodiments provided in the present disclosure, the present disclosure discloses the following technical effects:

Using the embodiments of the present application, information in a user concerned application program may be displayed directly in a lock screen interface of a mobile terminal device, without the need of performing a series of operations such as unlocking, searching an application program icon, and clicking the icon to start the application program. Therefore, the operation path of acquiring information by the user is shortened. Moreover, information displayed to the user may be a result obtained after aggregating concerned information in multiple concerned application programs, and therefore, the user can view information of multiple application programs in a single interface, thereby overcoming the problem of scattered information, simplifying operations of the user and improving user experience.

In addition, content data of a third party may be acquired from a third-party server via a server end, and is then pushed to a client end in time using a mechanism such as message push. Therefore, more content categories may be aggregated into a lock screen application client in this manner, which is very easy to be extended. As compared with existing technologies, a greater flexibility is achieved and content organization is more independent, with more accurate and timely information.

Moreover, by acquiring information that is pending for display directly from an information source server, a user can acquire specific information thereof without opening a concerned application program. Furthermore, the user can pay attention to an application program that has not been installed in a current mobile terminal. A lock screen application program can still display information of this type of application program to the user. In short, the user can acquire information provided by an application program without the need of opening or even installing the application program, thus saving the resources of the mobile terminal device, power reducing the power consumption of the mobile terminal device due to running of a large number of concerned application programs, and facilitating the improvement of the performance of the mobile terminal device.

Apparently, any product implementing the present disclosure does not need to achieve all of the above-mentioned advantages at the same time.

### BRIEF DESCRIPTION OF THE DRAWINGS

In order to explain the technical solutions in the embodiments of the present disclosure or the existing technologies more clearly, accompanying drawings used in the embodiments will be described briefly hereinafter. The accompanying drawings described hereinafter are merely some embodiments of the present disclosure. One of ordinary skill in the art can obtain other drawings based on these accompanying drawings without any creative effort.

FIG. 1 is a flowchart of a method provided in an embodiment of the present disclosure.

FIGS. 2-1-2-4 are schematic diagrams of a display interface provided in embodiments of the present disclosure.

FIG. 3 is a schematic diagram of another display interface provided in an embodiment of the present disclosure.

FIG. 4 is a flowchart of another method provided in an embodiment of the present disclosure.

FIG. 5 is a schematic diagram of a client apparatus provided in an embodiment of the present disclosure.

FIG. 6 is a schematic diagram of a server apparatus provided in an embodiment of the present disclosure.

### DETAILED DESCRIPTION

Technical schemes in the embodiments of the present disclosure will be described clearly and completely with the accompanying drawings in the embodiments of the present application. The described embodiments are merely a part, but not all, of the embodiments of the present disclosure. All other embodiments obtained by one of ordinary skill in the art based on the embodiments in the present disclosure shall fall within the protection scope of the present disclosure.

In the embodiments of the present disclosure, in order for a user to acquire information in application programs more conveniently and more timely, an application (App) may be provided. The user installs this application in a mobile terminal device thereof. The App can help the user to aggregate information of other applications that concern the user, so that the information in the applications may be displayed in a lock screen interface of the mobile terminal device. In this way, not only can the operation path of acquiring information by the user be shortened, information of the applications may also be aggregated for the user to view conveniently, thereby avoiding the problem of poor user experience caused by viewing scattered information from different applications. For ease of description and further for ease of differentiation from other application programs, the App provided in the embodiments of the present application is referred to herein as a “lock screen application”. Specific implementations will be described in detail below.

### First Embodiment

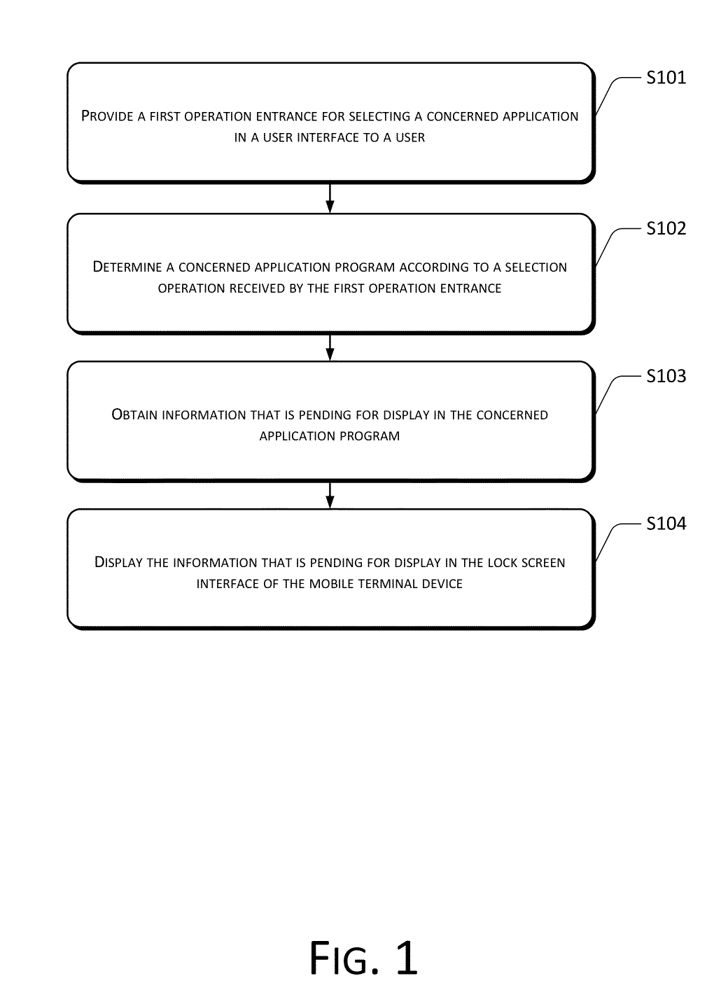

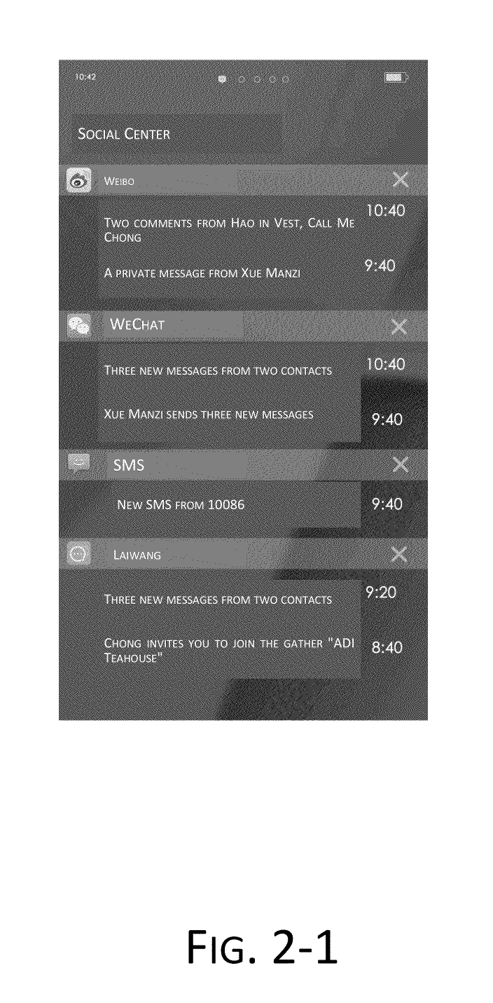

Referring to FIG. 1, an embodiment of the present disclosure first discloses a method of providing application program information in a mobile terminal device. The method may include the following blocks:

Block S101 provides a first operation entrance for selecting a concerned application in a user interface to a user.

In the embodiment of the present disclosure, different users may select concerned applications according to their needs. Therefore, a first operation entrance may be provided in a user interface of a lock screen application. The user installs the lock screen application program in a mobile terminal device thereof, and can use the first operation entrance after starting the application program to enter the user interface. Specifically, the first operation entrance may be an operation entrance that exists in a form such as a button, and can be operated when the user clicks the first operation entrance. Moreover, the first operation entrance may alternatively be a touch operation entrance. For example, after a touch operation entrance is provided and when a touch operation performed by the user on a touch screen is detected to satisfy a preset touch condition, an application program list may be displayed to the user so that the user selects an application that needs to be concerned from the application program list.

It should be noted that, when displaying selectable application programs to a user, applications that have been installed in the current terminal device may also be displayed. In an embodiment, applications that are not installed in the current terminal device may further be displayed. During selection, the user may select an application that he/she is interested in without distinguishing whether the application has been installed locally or not. In this way, the user may obtain some information provided by that application from the lock screen application even through that application is not installed locally. This not only reduces the number of applications installed by the user in the terminal, but also facilitates the user to view information pushed by applications that are not installed in the terminal while reducing the power consumption of the terminal. Details of how to obtain and display some information from an application that is not installed for the user will be described later.

Block S102 determines a concerned application program according to a selection operation received by the first operation entrance, wherein the concerned application program may include one or more application programs.

After the user performs a specific selection operation, an application program selected by the user may be directly determined as a current application program that is of interest to the user. For a same user, multiple concerned application programs may be selected.

Block S103 obtains information that is pending for display in the concerned application program.

Since the current concerned application of the user has been determined, information that is pending for display in the concerned application program may be obtained through the lock screen application in the embodiment of the present disclosure.

In an embodiment, when a screen of the mobile terminal device is activated to display a lock screen interface, the information that is pending for display in the concerned application program is obtained. The lock screen interface is an interface firstly displayed after the screen (touch screen) of the mobile terminal device is activated. In order to avoid operations of the user by mistake, common operations such as sliding and clicking are considered as invalid operations in the lock screen interface. Only when a specific operation is performed, the operation is considered as an active operation behavior of the user, and a response is provided. For example, a “slider” for performing an unlock operation may exist in the lock screen interface, and a direction for the unlock operation or the like is indicated. When the user drags the slider along the direction, it will be considered as the user wanting to unlock the screen, and a main interface of the mobile terminal device is entered to display icons of various application programs that have been installed, etc.

In an embodiment of the present disclosure, the information that is pending for display in the concerned application programs obtained by the lock screen application is generally the latest messages generated in the application programs. Many implementation methods exist for obtaining this type of information that is pending for display.

For example, in one implementation, if the concerned application program is an application program that has been locally installed, the concerned application program generally pushes some latest messages to a notification center of an operating system. Therefore, the lock screen application can acquire information that is pending for display in the concerned application from the notification center of the operating system. Apparently, in this implementation, support from the operating system is generally needed. For example, some low versions of Android operating systems may not be able to provide support. In addition, not each concerned application program will push messages to the notification center of the operating system, and therefore latest messages of these applications cannot be obtained from the notification center of the operating system. For those concerned application programs that have not been installed locally in the device, latest messages thereof cannot be acquired in this manner.

Therefore, in an embodiment of the present disclosure, the information that is pending for display may be acquired directly from a server of a message provider. In order to realize this approach, after the concerned application program information of the user is determined, a client of the lock screen application may send identification information of the concerned application program and identification information of the current mobile terminal device to a server of the lock screen application for storage. (In order to differentiate from a server corresponding to the concerned application program, the server of the lock screen application is referred to as a “first server”, and one or more servers corresponding to the concerned application program are referred to as “second servers”.) The identification information of the mobile terminal device may include a hardware identifier, such as an ID of the mobile terminal device, which is used to differentiate different mobile terminal devices. Therefore, the first server may store a correspondence relationship between the identification information of the mobile terminal device and the concerned application program, wherein a single device ID may be corresponding to multiple concerned application program. After acquiring the information, the first server may access a second server corresponding to the concerned application program according to a certain strategy (e.g., at a certain time interval, etc.). If an update is found in the second server, the first server may acquire updated information, and store the updated information in the first server. Moreover, the acquired information may also be organized based on categories of the concerned application programs (which will be described in detail hereinafter).

In short, the lock screen application may obtain information that is pending for display in application programs which are of interest to the user from the first server. In a specific implementation, the client of the lock screen application may send a request of acquiring information that is pending for display to the first server and include identity information such as a device ID in the request upon finding that the screen of the terminal device is activated to display the lock screen interface. In this way, the first server may determine the device ID related information that is pending for display based on the device ID and the previously stored correspondence relationship, and return the information to the client. As such, the client can acquire the information that is to be displayed. Or, in another implementation, the first server may actively push the information that is to be displayed to the client of the lock screen application. After receiving the display-pending information pushed by the first server, the client may automatically activate the screen of the mobile terminal device, and display the display-pending information pushed by the first server on the lock screen interface.

Information such as the latest message provided by a target application program generally comes from a second server corresponding to the target application program. Therefore, in this implementation, limits of the operating system of the terminal device and the target application program may be overcome. Moreover, even if the user does not install a certain application program, some information can still be acquired from a server of that application program, and displayed in the lock screen interface for the user. Apparently, for an application program that has not been installed, the user can merely view the information that is pending for display in the interface provided by the lock screen application.

It should be noted that, in a process of acquiring the information that is pending for display from the second server of the concerned application program, some display-pending information may be general information, such as the latest report of a certain news website, etc. However, some display-pending information is private information of the user, i.e., display-pending information that can be acquired from the corresponding second server only after the user logs in using account information (such as a user name and a password) registered in the second server. Examples include information of the user in a social type application such as Laiwang, Weibo and WeChat, etc., or information in an e-mail box, etc. In order to acquire the private information, In one embodiment, when the user selects a concerned application program, the client of the lock screen application may first acquire account information of the user registered in a second server corresponding to the concerned application, and upload the account information to the first server for storage. In other words, in addition to storing the identification information of the concerned application program, the first server may further store the account information of the user registered in the second server corresponding to the application program. In this way, the first server may acquire the information that is pending for display from the second server corresponding to the concerned application program based on the identification information of the concerned application program and the account information of the user.

Specifically, a number of approaches may be used for acquiring account information of a user registered in a second server corresponding to a concerned application program. For example, in one simple approach, after finding that the user selects a certain concerned application program that may need to obtain account information, an operation entrance (for example, an input box) for inputting account information may be provided in the user interface of the lock screen application, and a prompt is provided to the user for inputting the account information thereof. After the user inputs the account information, the account information may be uploaded to the first server for storage. Apparently, for a concerned application program running in the mobile terminal device, account information of the user is generally recorded directly in the mobile terminal device, and the user directly logs into the second server each time when the application program is entered. Therefore, in order to further simplify operations of the user, the lock screen application may directly bind the account information in the concerned application program, i.e., directly read the account information of the concerned application program locally from the mobile terminal device. Apparently, an inquiry message may be sent to the user before binding. For example, a dialog box is popped up, displaying that “lock screen application is going to bind your account information automatically”, and options such as “Yes” and “No” are provided. After a confirmation instruction is received from the user, the account information is acquired based on information locally stored in the mobile terminal device, and the account information is uploaded to the first server. In other words, in the second implementation, operations such as repeatedly inputting a user name and a password by the user are avoided.

In short, in specific implementations, the client of the lock screen application may read some information that is pending for display from the notification center of the operating system of the mobile terminal device, and may alternatively request for some information that is pending for display from the first server associated with the lock screen application. Apparently, the information that is pending for display may also be acquired by using the above two approaches at the same time.

Block S104 displays the information that is pending for display in the lock screen interface of the mobile terminal device.

In existing technologies, the lock screen interface generally displays some simple information only, for example, information such as time and weather may also be displayed in addition to the slider for performing the unlock operation as described above. In the embodiment of the present disclosure, some display-pending information acquired from the application program that is currently of interest to the user may be displayed in the lock screen interface. In other words, in the embodiment of the present disclosure, the user may directly view information in various concerned application programs in the lock screen interface without the need of performing a series of operations such as unlocking, searching for an icon of an application program, and clicking the icon to start the application program, etc., thus shortening an operation path of acquiring information by the user. Moreover, information displayed to the user by the lock screen application may be a result of aggregation of information to be followed in multiple concerned application programs. Therefore, the user can view information of multiple application programs in a single interface, thereby overcoming the problem of complicated operations due to scattered information.

In addition, content data of a third party may be acquired from a third-party server via a server end, and the content data is pushed to a client end in time using a mechanism such as message push. Therefore, more content categories may be aggregated into the client of the lock screen application in this manner, which is very easy to be extended. As compared with the existing technologies, a greater flexibility is achieved and content organization is more independent, with more accurate and timely information.

Moreover, by acquiring the information that is pending to be displayed directly from an information source server, the user can acquire specific information without opening an application program he/she is concerned with. Furthermore, the user can pay attention to an application program that has not been installed in the current mobile terminal, and the lock screen application can display information of that application program to the user. In short, the user can acquire information provided by an application program without the need of opening or even installing that application program, thus saving the resources of the mobile terminal device, reducing the power consumption of the mobile terminal device due to running of a large number of concerned application programs and facilitating the improvement in the performance of the mobile terminal device.

It should be noted that, in specific implementations, in order for the display-pending information acquired by the lock screen application to be displayed in the lock screen interface of the mobile terminal device, the lock screen application may register a “screen on” event in the operating system of the mobile terminal device in advance. As such, when the screen is activated, the lock screen application is allowed to directly display the obtained information that is pending for display in the lock screen interface.

In addition, it should be noted that, when the number of the concerned application programs is large, a situation that information is relatively cluttered may happen when information that is pending for display in the application programs is displayed to the user. In order to solve this problem, in the embodiment of the present disclosure, when the display-pending information is displayed, multiple lock screen interfaces may be included, and various pieces of the display-pending information may be categorically displayed in different lock screen interfaces. A same lock screen interface displays display-pending information corresponding to a same type of concerned application programs. In other words, the concerned application programs may first be categorized before display, e.g., categorized into a social category, a news category, a website service category, a picture category, etc. (which category an application program belongs to may be determined according to labels that are assigned in advance to common application programs, and reference may be made to implementations in existing technologies, which are not described in detail herein). Then, display-pending information acquired from the concerned application programs may then be organized, and display-pending information in application programs of a same category is organized into a same lock screen interface. For a situation that the display-pending information is obtained from the first server, the task of organizing the display-pending information may be performed by the first server. In other words, after acquiring the display-pending information, the first server may directly organize the display-pending information according to respective categories of the application programs. In this way, after a request for acquiring display-pending information is received from the client, the display-pending information including category information may be returned directly. The client may quickly display the display-pending information in various categories of concerned application programs in different lock screen interfaces.

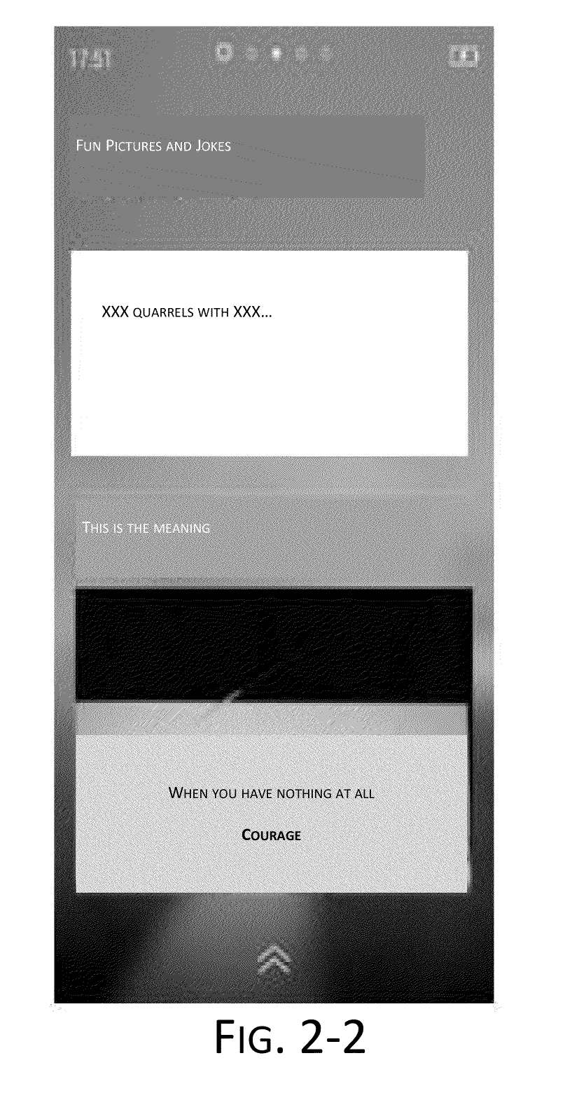

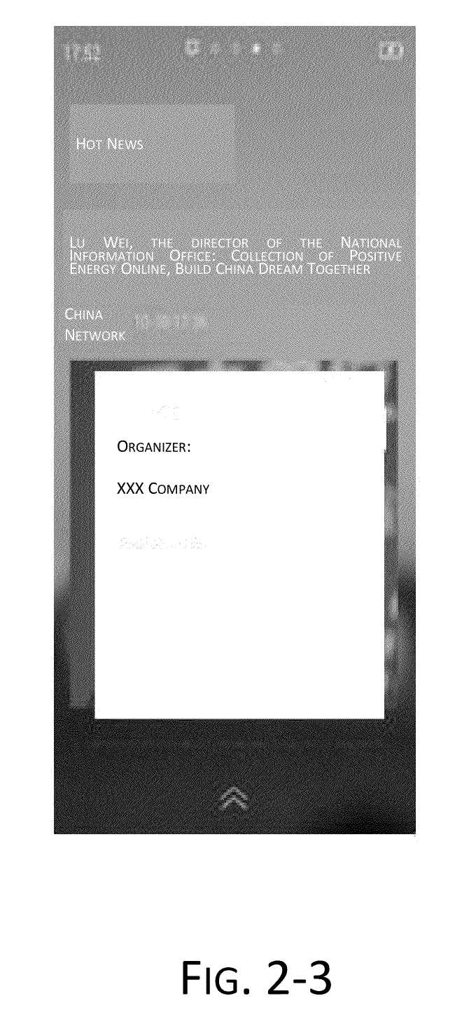

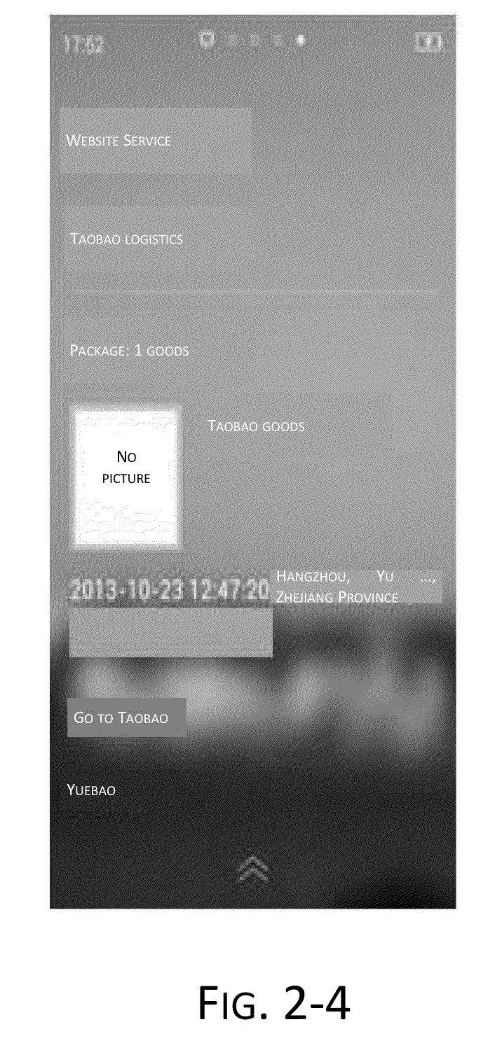

For example, referring to FIG. 2-1, FIG. 2-2, FIG. 2-3 and FIG. 2-4, four lock screen interfaces are shown, where FIG. 2-1 shows display-pending information in various concerned application programs (such as Laiwang, Weibo, WeChat, SMS, etc.) under a category of “Social Center”, FIG. 2-2 shows display-pending information in various concerned application programs under a category of “Fun Pictures and Jokes”, FIG. 2-3 shows display-pending information in various concerned application programs under a category of “Hot News”, and FIG. 2-4 shows display-pending information in various concerned application programs under a category of “Website Service”. In a specific implementation, switching may be performed among different lock screen interfaces by such manner as sliding horizontally or vertically, etc.

In a real application, after the screen is activated to enter the lock screen interface, various pieces of display-pending information acquired by the lock screen application may be directly displayed. Apparently, in order to prevent the directly displayed information from affecting other operations of the user when the user does not need to view the display-pending information in the various concerned application programs, in a specific implementation, after the screen is activated to enter the lock screen interface, an operation entrance is displayed first. For example, as indicated by 301 in FIG. 3, after an operation of the user such as clicking is received by that operation entrance, this proves that the user confirms the need of acquiring the display-pending information. The various pieces of acquired display-pending information are then displayed in the lock screen interface.

After the various pieces of display-pending information are displayed in the lock screen interface, the user may directly view the information. Apparently, since the information in various application programs is aggregated and displayed, the information displayed in the lock screen interface may be just a small amount of information such as an abstract of the information. If the user desires to acquire details of a certain piece of information, the user may perform an operation such as clicking on that piece of information. After receiving the operation, the lock screen application may determine a target application program corresponding to that piece of display-pending information, and directly start the target application program through an interface provided by the operating system, for example. In this way, an interface of the target application program may be entered, and the user may perform operations in the interface to view information details.

Apparently, details of the information that is pending for display may not be directly displayed in a main interface of the target application program, but is displayed in a certain specific sub-interface of the target application. For example, after the lock screen application acquires a private message received from Weibo and starts Weibo to enter a main interface of Weibo, the user can view detailed information of this private message only after clicking a button such as “Private Message” in the main interface to enter a sub-interface where the private message is located. In order to further shorten an operation path of acquiring information for the user, in the embodiment of the present disclosure, information in the target application, such as an information organization, a display rule and parameters needed for entering the sub-interface, etc., may be acquired in advance. In this way, when the user needs to acquire details of a certain piece of display-pending information, the lock screen application may send a start request to the target application based on the information display rule and the corresponding parameter information of the target application when starting the target application. As such, the target application may directly enter into the sub-interface where the designated display-pending information is located after started, which is equivalent to helping the user to save operations of entering into the sub-interface via a trigger control after entering into the main interface, for example, thereby further shortening the operation path of the user.

During a process where the user clicks a piece of display-pending information to enter a target application, the lock screen application (which is equivalent to a calling party) invokes the target application (which serves as a called party). In this process, the calling party may generate a call uniform resource locator (URL) based on information of the called party, and transfer the URL to the operating system (for example, generating an intent in an android system to be transferred to the system). In order to enter into the sub-interface of the target application more directly to realize more precise positioning, parameter rules in the target application may be acquired in advance. As such, the calling party may put together the calling URL according to the parameter rules of the called party, and generate the intent in the android system for transferring to the system.

Alipay is used as an example: alipays://platformapi/startapp?appld=20000032.

A processing program of a url schema of a called party registers itself in a system, i.e., the “alipays://” part in the URL.

The parameter part includes a URL path and specific parameters, and the called party App has rules. The calling party generates a specific address according to those rules so as to achieve the objective of directly reaching a specific page in the called party App.

Explanations are made herein in two aspects as follows:

Firstly, since the user clicks the display-pending information in the lock screen interface to trigger an operation of entering a specific application, this operation may be directly used as a replacement for a user operation of dragging a unlock slider, i.e., the user directly enters into an interface of a target application while performing unlocking of the screen. Apparently, if the user has set up a password, an interface for inputting the password may be displayed first after the users clicks a piece of the display-pending information provided by the lock screen application. Upon successful verification, the operating system displays the interface of the target application.

Secondly, after clicking a piece of the display-pending information provided by the lock screen application, the user enters the interface of the target application corresponding to the display-pending information. After finishing the reading of this piece of the display-pending information, the user may directly select an icon of the lock screen application on a desktop of the terminal device to enter the interface of the lock screen application if the user wants to view another piece of the display-pending information provided by the lock screen application. At this moment, the interface of the lock screen application may display the display-pending information of various concerned application programs that has been obtained, and the user may continue to select other pieces of the display-pending information for viewing the details thereof. Or, in another implementation, the user may close the screen of the terminal device and later activate the screen again to allow viewing various pieces of the display-pending information provided by the lock screen application in the lock screen interface.

In the above two implementations, the user still needs to perform multiple operations in order to switch to other applications for viewing information details. In order to avoid this situation, after the user enters an interface (a main interface or a sub-interface) of a certain specific target application, an operation entrance may be displayed on an upper layer of the interface. After the user enters via the operation entrance, the target application may send a callback instruction to the lock screen application to directly display the interface of the lock screen application, so that the interface of the lock screen application may display various pieces of the display-pending information to the user. Alternatively, various pieces of the display-pending information acquired by the lock screen application may further be displayed directly when the interface of the target application is displayed. As such, the user may directly send a request for viewing another piece of the display-pending information without the need of exiting from the interface of a current application and executing operations such as activating the screen. Correspondingly, after receiving the request for viewing the details of new display-pending information, the lock screen application starts an application program corresponding to the new display-pending information, and displays the details of the display-pending information in an interface of that application program.

A number of implementations may exist for displaying various pieces of display-pending information acquired by the lock screen application while implementing an interface of a target application program. For example, in one implementation, when entering into an interface of a target application program, a display-pending information list provided by the lock screen application is embedded into the interface of the target application program, or a small window is drawn on the interface of the target application program with the display-pending information list being displayed in the window. In this way, after viewing details of a piece of the display-pending information list in the interface of the target application program, the user may directly select details of other pieces of the display-pending information for viewing from the display-pending information list. Apparently, in the foregoing implementations, support from the target application program is needed to be obtained first.

In short, in an embodiment of the present disclosure, the lock screen application performs aggregation on information of different sources, and enables the user to obtain all related information that he/she desires from a page displayed in the lock screen interface, thus shortening the path of acquiring a message as compared with the existing technologies.

Finally, it should be noted that, in an embodiment of the present disclosure, the operating system in the mobile terminal device may be an Android system, an iOS system, a Windows system, etc.

The method provided in the embodiments of the present disclosure is described in detail from the perspective of a client in the first embodiment. A specific implementation (i.e., acquiring display-pending information from a second server) is introduced hereinafter from the perspective of a server (i.e., the first server described in the foregoing description).

### Second Embodiment

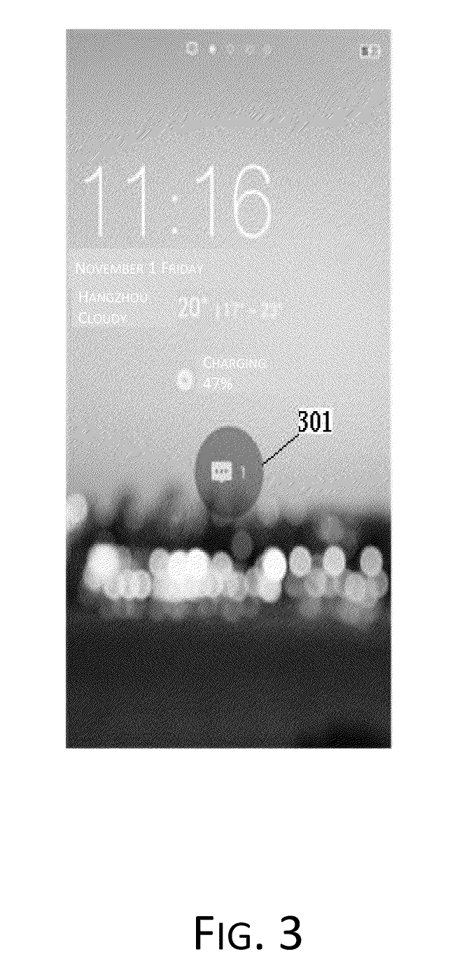

Referring to FIG. 4, from the perspective of the first server, the embodiments of the present disclosure further provide a method of providing application program information. The method may include the following blocks:

Block S401 receives and stores identity information of a concerned application program and identity information of a corresponding mobile terminal device that is uploaded by a client.

Block S402 obtains display-pending information from at least one second server corresponding to the concerned application program based on the stored identity information of the concerned application program, and stores a correspondence relationship between the display-pending information and an identity of the mobile terminal device; and

Block S403 provides the display-pending information to a client of the mobile terminal device according to the stored correspondence relationship.

In a specific implementation, the first server may return the obtained display-pending information to the client after receiving a request from the client. In other words, after receiving the request for obtaining display-pending information from the client, the first server reads corresponding display-pending information according to the identity information of the mobile terminal device included in the request and the stored correspondence relationship, and returns a response message to facilitate the client to display the display-pending information in a lock screen interface of the mobile terminal device. Alternatively, the first server may directly push the obtained display-pending information to the client. In other words, the first server may push the obtained display-pending information to the client of the mobile terminal device based on the stored correspondence relationship, so that the client displays the display-pending information in the lock screen interface of the mobile terminal device.

If obtaining private information of the user in the second server is needed, account information that is registered by the user in the second server corresponding to the concerned application program and that is uploaded by the client may be received and stored. In this way, when the display-pending information is obtained from the second server corresponding to the concerned application program, the display-pending information may be obtained from the second server corresponding to the concerned application program based on the identity information of the concerned application program and the account information of the user.

After the display-pending information is obtained, the first server may further classify and organize the display-pending information based on respective categories to which the concerned application programs belong. In this way, when the request for obtaining the display-pending information is received, this type of category information may also be returned to the client, so that the client may display the display-pending information of various categories in different pages.

It should be noted that, the second embodiment describes a specific implementation in the first embodiment from the perspective of a server. Compared with the description in first embodiment, specific implementation details are the same, and merely the perspectives of descriptions are different. Therefore, reference can be made to the description in the first embodiment, and details will not be repeatedly described herein.

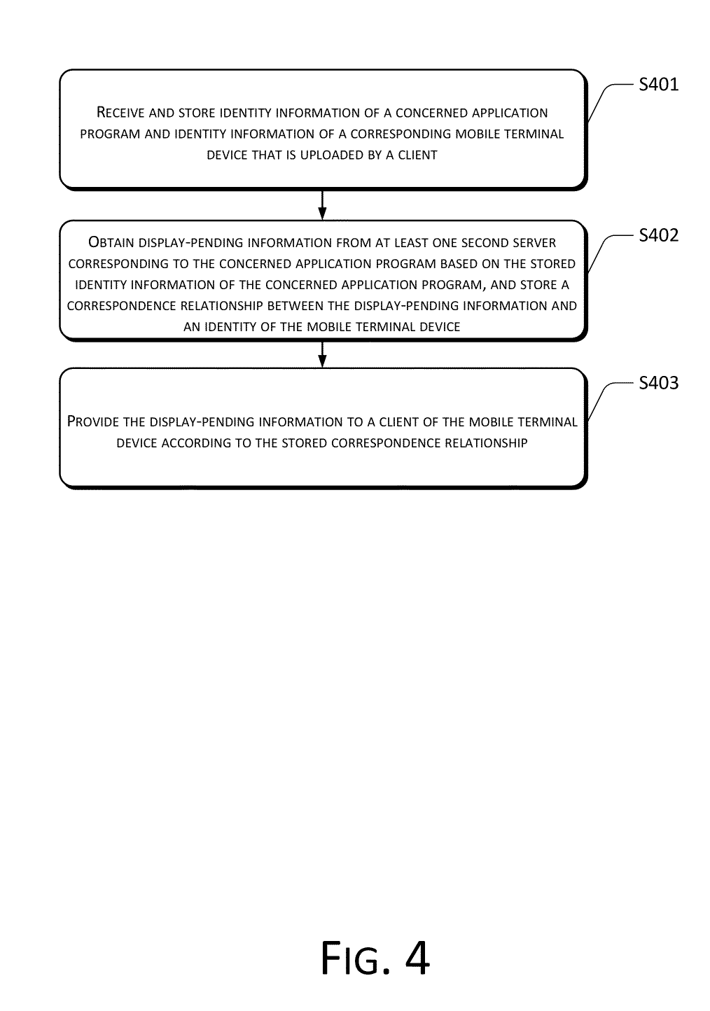

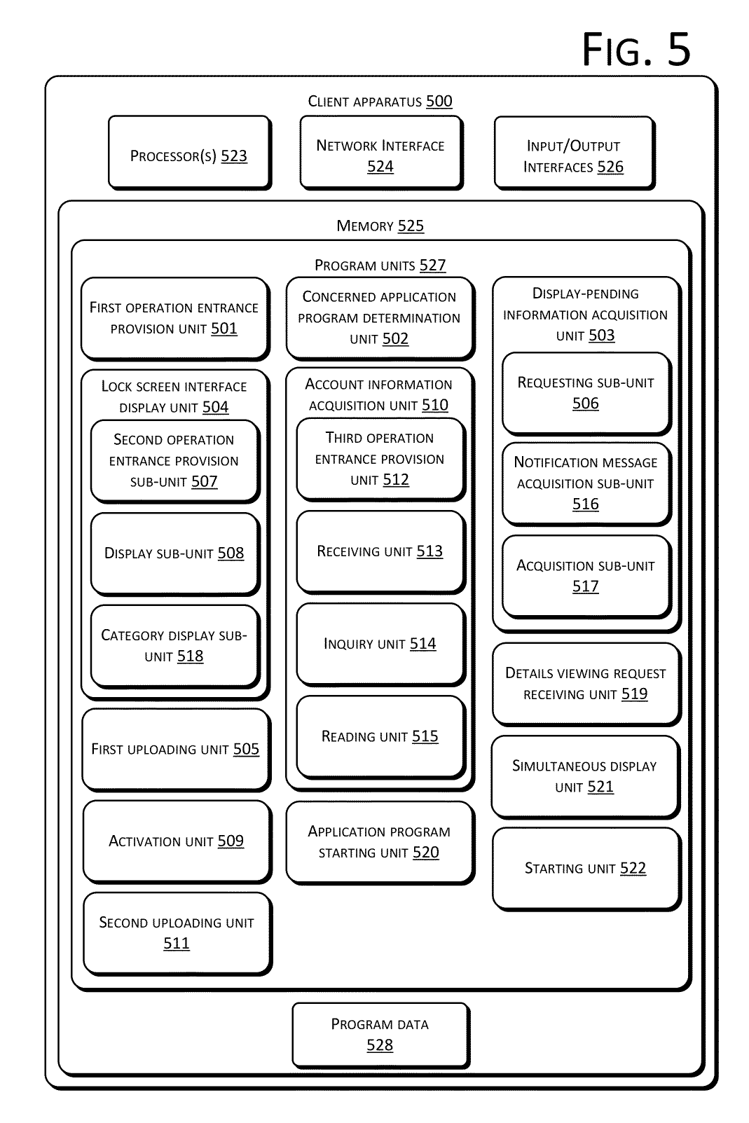

Corresponding to the method of providing application program information in a mobile terminal device provided in the first embodiment of the present disclosure, the embodiments of the present disclosure further provides an apparatus 500 for providing application program information in a mobile terminal device. The apparatus 500 is located in a client. With reference to FIG. 5, the apparatus 500 may include:

a first operation entrance provision unit 501 used for providing a first operation entrance for selecting a concerned application program to a user in a user interface;

a concerned application program determination unit 502 used for determining the concerned application program based on a selection operation received via the first operation entrance, wherein the concerned application program includes one or more application programs;

a display-pending information acquisition unit 503 used for obtaining information that is pending for display in the concerned application program; and

a lock screen interface display unit 504 used for displaying the information that is pending for display in a lock screen interface of the mobile terminal device.

During specific implementations, the concerned application program may include an application program that is not installed in the mobile terminal device.

In order to acquire information from an application program that is not installed, or to overcome some limits of an operating system or a program itself for an installed application program, the display-pending information may be acquired by the first server, i.e., the apparatus of the client may further include:

a first uploading unit 505, used for sending identity information of the concerned application program and identity information of the current mobile terminal device to the first server for storage after the concerned application program is determined based on the selection operation received via the first operation entrance, in order to facilitate the first server to acquire the display-pending information from a second server corresponding to the concerned application program based on the identity information of the concerned application program, and store a correspondence relationship between the display-pending information and an identity of the mobile terminal device in the first server.

The display-pending information acquisition unit is used for:

acquiring the display-pending information in the concerned application program from the first server.

In this situation of acquiring the display-pending information from the first server, the display-pending information acquisition unit may include:

a requesting sub-unit 506, used for sending a request message for acquiring the display-pending information of the concerned application program to the first server when a screen of the mobile terminal device is activated to display the lock screen interface, the request message including the identity information of the mobile terminal device, so that the first server determines corresponding display-pending information based on the identity of the mobile terminal device and the correspondence relationship and returns a response message, and therefore the client may obtain the display-pending information in the concerned application program according to the response message returned by the first server.

During specific implementations, the lock screen interface display unit includes:

a second operation entrance provision sub-unit 507, used for providing a second operation entrance in the lock screen interface; and

a display sub-unit 508, used for displaying display-pending information in the lock screen interface upon receiving the request of the user via the second operation entrance.

In another implementation, the first server may provide the display-pending information to the client by means of active push. In this case, the display-pending information acquisition unit may be configured to receive the display-pending information of the concerned application program pushed by the first server. In this case, the apparatus of the client may further include:

an activation unit 509, used for activating the screen of the mobile terminal device after the display-pending information pushed by the first server is received to facilitate the display of the display-pending information in the lock screen interface of the mobile terminal device.

If the display-pending information includes private information of the user, the apparatus may further include:

an account information acquisition unit 510 used for acquiring account information of the user registered in a second server corresponding to the concerned application program; and

a second uploading unit 511 used for uploading the account information to the first server for storage, so that the first server acquires the display-pending information from the second server corresponding to the concerned application program, based on the identity information of the concerned application program and the account information of the user.

The account information acquisition unit may include:

a third operation entrance provision unit 512 used for providing a third operation entrance for inputting the account information when the application program is selected; and

a receiving unit 513 used for receiving the account information input by the user via the third operation entrance.

Alternatively, in another implementation, the account information acquisition unit may include:

an inquiry unit 514 used for, if the account information of the user registered in the second server corresponding to the concerned application program is locally stored in the mobile terminal device, sending a message inquiring the user whether to agree to perform account binding when the application program is selected; and

a reading unit 515 used for acquiring the account information based on the information locally stored in the mobile terminal device when an instruction of agreeing to perform the account binding is received.

In another implementation, when the concerned application program is an application program that has been installed in the mobile terminal device, the display-pending information acquisition unit may include:

a notification message acquisition sub-unit 516 used for acquiring a notification message pushed by the concerned application program to the mobile terminal device; and

an acquisition sub-unit 517 used for acquiring the display-pending information in the concerned application program according to the notification message.

In addition, to avoid relatively cluttered content displayed by the lock screen interface due to a large number of pieces of display-pending information, multiple lock screen interfaces may be provided, and the lock screen interface display unit may include:

a category display sub-unit 518 used for displaying the display-pending information in the lock screen interface in a categorized manner; where a same lock screen interface displays display-pending information corresponding to a same type of concerned application program.

When the concerned application program is an application program that has been installed, the apparatus may further include:

a details viewing request receiving unit 519 used for receiving a request for viewing details of first display-pending information in the lock screen interface; and

an application program starting unit 520 used for starting a first application program corresponding to the first display-pending information to facilitate displaying details of the display-pending information in the first application program.

In order to perform more accurate positioning, the application program starting unit 520 may be configured to:

send a start request to the first App based on information display and corresponding parameter information rules of the first application program, so as to directly enter a sub-interface where the designated display-pending information is located after the first application program is started.

In addition, in order to facilitate switching to an application program interface corresponding to another piece of the display-pending information by the user to view details, the apparatus may further include:

a simultaneous display unit 521 used for displaying the display-pending information at the same time when the interface of the first application program is exhibited; and

a starting unit 522 used for start a second application program corresponding to second display-pending information, so as to display details of the display-pending information in an interface of the second application program when a request for viewing details of the second display-pending information is received.

In one embodiment, the apparatus 500 further include, but is not limited to, one or more processors 523, a network interface 524, memory 525 and an input/output interface 526.

The memory 525 may include computer-readable media in the form of volatile memory, such as random-access memory (RAM) and/or non-volatile memory, such as read only memory (ROM) or flash RAM. The memory 525 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 525 may include program units 527 and program data 528. In one embodiment, the program units 527 may include the units and sub-units of the client apparatus 500 as described above.

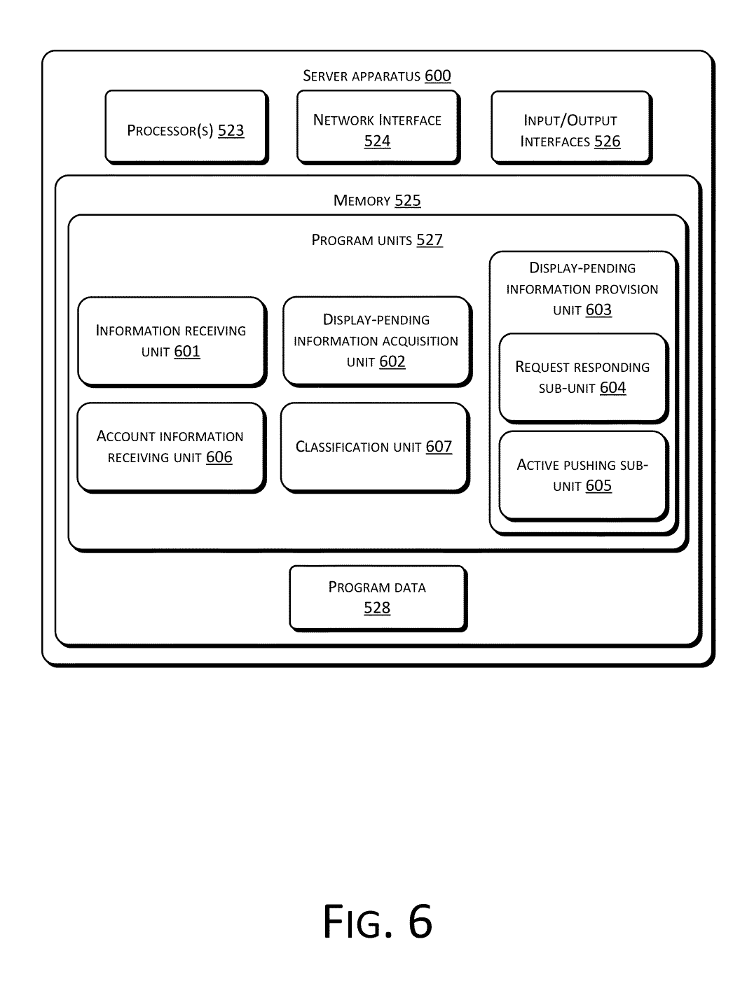

Corresponding to the method for providing application program information provided in the second embodiment of the present disclosure, the embodiments of the present disclosure further provide an apparatus 600 of providing application program information. The apparatus 600 is located at a first server. As shown in FIG. 6, the apparatus 600 may include:

an information receiving unit 601 used for receiving and storing identity information of a concerned application program and identity information of a corresponding mobile terminal device that is uploaded by a client;

a display-pending information acquisition unit 602 used for obtaining information that is pending for display from at least one second server corresponding to the concerned application program based on the stored identity information of the concerned application program, and storing a correspondence relationship between the information that is pending for display and an identity of the mobile terminal device; and

a display-pending information provision unit 603 used for providing the information that is pending for display to the client of the mobile terminal device based on the stored correspondence relationship.

The display-pending information provision unit 603 may include:

a request responding sub-unit 604 used for reading corresponding display-pending information based on the identity information of the mobile terminal device included in the request and the correspondence relationship and returning a response message when a request of acquiring the display-pending information is received from the client, so that the client displays the display-pending information in the lock screen interface of the mobile terminal device; or

an active pushing sub-unit 605 used for pushing the display-pending information to the client of the mobile terminal device based on the correspondence relationship to facilitating the client to display the display-pending information in the lock screen interface of the mobile terminal device.

In order to obtain private information of the user, the apparatus may further include:

an account information receiving unit 606 used for receiving and storing account information of the user that is registered to a second server corresponding to the concerned application program and is uploaded by the client;

the display-pending information acquisition unit 602 may be used for:

obtaining the display-pending information from the second server corresponding to the concerned application program based on the identity information of the concerned application program and the account information of the user.

In addition, the apparatus 600 may further include:

a classification unit 607 used for classifying the acquired display-pending information based on categories of the concerned application programs.

Using the technical schemes provided by the embodiments of the present disclosure, a user can view information in an application program in a lock screen interface of a mobile terminal device, without the need of performing a series of operations such as unlocking, searching an application program icon, and clicking the icon to start the application program. Therefore, the operation path of acquiring information by the user is shortened. Moreover, information displayed to the user may be a result obtained after aggregating concerned information in multiple concerned application programs. Therefore, the user can view information of multiple application programs in a single interface, thereby overcoming the problem of scattered information, simplifying operations of the user and improving user experience.

Through the description of the foregoing implementations, one of ordinary skill in the art can clearly understand that the present disclosure can be implemented using software with a necessary universal hardware platform. Based on such understanding, the technical solution of the present disclosure in essence or the part which contributes to the existing technologies can be embodied in a form of a software product. The computer software product may be stored in a storage medium, such as a ROM/RAM, a magnetic disk, and an optical disk, etc., and includes instructions for instructing a computing device (which may be a personal computer, a server, a network device, etc.) to perform the method described in each embodiment or parts of the embodiment of the present disclosure.

The embodiments in the specification are described in a progressive manner, identical or similar parts of the embodiments may be obtained with reference to each other. Each embodiment emphasizes an aspect different from other embodiments. Particularly, for the systems or system embodiments, descriptions thereof are relatively simple because they are basically similar to the method embodiments, and relevant parts may be obtained with reference to respective parts of the method embodiments. The systems and system embodiments described above are merely exemplary, and units described as separated components may be or may not be separated physically. Components displayed as units may be or may not be physical units, i.e., may be located at a same location, or may be distributed among multiple network units. Parts or all of the modules may be selected to implement the objective of the technical scheme of an embodiment according to an actual need. One of ordinary skill in the art can understand and implement the present disclosure without any creative effort.

The methods and the apparatuses of providing application program information in a mobile terminal device that are provided in the present disclosure are described in detail above. The specification describes the principles and the implementations of the present disclosure using specific examples. The descriptions of the foregoing embodiments are merely used to help understanding of the methods and core concepts of the present disclosure. Furthermore, for one of ordinary skill in the art, variations may be made to specific implementations and application scopes according to the ideas of the present disclosure. In view of the above, the content of the present disclosure should not be construed as a limitation to the present application.

What is claimed is:

1. A method of providing application program information in a mobile terminal device, comprising:
providing a first operation entrance for selecting a concerned application program in a user interface to a user;
determining the concerned application program according to a selection operation received via the first operation entrance;
obtaining information that is pending to be displayed in the concerned application program; and
displaying the information that is pending to be displayed in a lock screen interface of the mobile terminal device.

2. The method according to claim 1, wherein the concerned application program comprises one or more application programs.

3. The method according to claim 1, wherein the concerned application program comprises an application program that is not installed in the mobile terminal device.

4. The method according to claim 1, wherein, after determining the concerned application program according to the selection operation received via the first operation entrance, the method further comprises:
sending identity information of the concerned application program and identity information of the mobile terminal device to a first server for storage to facilitate the first server to obtain the information that is pending to be displayed from a second server corresponding to the concerned application program based on the identity information of the concerned application program; and
storing a correspondence relationship between the information that is pending to be displayed and the identity information of the mobile terminal device in the first server, wherein obtaining the information that is pending to be displayed in the concerned application program comprises obtaining the information that is pending to be displayed in the concerned application program from the first server.

5. The method according to claim 4, wherein obtaining the information that is pending to be displayed in the concerned application program from the first server comprises:
sending a request message of obtaining the information that is pending to be displayed in the concerned application program to the first server when a screen of the mobile terminal device is activated to display the lock screen interface, wherein the request message includes the identity information of the mobile terminal device to facilitate the first server to read the information that is pending to be displayed based on the identity information of the mobile terminal device and the correspondence relationship, and to return a response message.

6. The method according to claim 5, wherein displaying the information that is pending to be displayed in the lock screen interface comprises:
providing a second operation entrance in the lock screen interface; and
displaying the information that is pending to be displayed in the lock screen interface in response to receiving a request from the user via the second operation entrance.

7. The method according to claim 4, wherein obtaining the information that is pending to be displayed in the concerned application program from the first server comprises receiving the information that is pending to be displayed in the concerned application program pushed by the first server, and wherein the method further comprises activating the screen of the mobile terminal device to facilitate the displaying of the information that is pending to be displayed in the lock screen interface of the mobile terminal device.

8. The method according to claim 4, wherein the information that is pending to be displayed comprises private information of the user, and the method further comprises:
obtaining account information of the user registered to the second server corresponding to the concerned application program;
uploading the account information to the first server for storage to facilitate the first server to obtain the information that is pending to be displayed from the second server corresponding to the concerned application program based on the identity information of the concerned application program and the account information of the user.

9. The method according to claim 1, wherein, when the concerned application program comprises an application program that is installed in the mobile terminal device, obtaining the information that is pending to be displayed in the concerned application program comprises:
acquiring a notification message that is pushed from the concerned application program to the mobile terminal device; and
acquiring the information that is pending to be displayed in the concerned application program based on the notification message.

10. The method according to claim 1, wherein the lock screen interface includes a plurality of lock screen interfaces, and displaying the information that is pending to be displayed in the lock screen interface comprises:
categorically displaying the information that is pending to be displayed in different lock screen interfaces, wherein a same lock screen interface displays display-pending information corresponding to a same category of concerned application programs.

11. The method according to claim 1, wherein, when the concerned application program comprises an installed application program, and the method further comprises:
receiving a request for viewing details of first display-pending information in the lock screen interface; and
starting a first application program corresponding to the first display-pending information to facilitate displaying of the details of the first display-pending information in an interface of the first application program.

12. The method according to claim 11, wherein starting the first application program corresponding to the first display-pending information comprises sending a start request to the first application program based on an information display rule and corresponding parameter information of the first application program so that the first application program directly enters a sub-interface where the first display-pending information is located upon being started.

13. The method according to claim 11, further comprising:
displaying the display-pending information at the same time when the interface of the first application program is displayed; and
starting a second application program corresponding to second display-pending information upon receiving a request for viewing details of the second display-pending information to facilitate displaying of the details of the second display-pending information in an interface of the second application program.

14. One or more computer-readable media storing executable instructions that, when executed by one or more processors, cause the one or more processors to perform acts comprising:
receiving and storing identity information of a concerned application program and identity information of a corresponding mobile terminal device that is uploaded by a client, and;
acquiring display-pending information from at least one second server corresponding to the concerned application program based on the stored identity information of the concerned application program;
storing a correspondence relationship between the display-pending information and the identity information of the mobile terminal device; and
providing the display-pending information to the client of the mobile terminal device according to the stored correspondence relationship.

15. The one or more computer-readable media according to claim 14, wherein providing the display-pending information to the client of the mobile terminal device according to the stored correspondence relationship comprises:
reading corresponding display-pending information based on the identity information mobile of the mobile terminal device included in the response message and the correspondence relationship, and returning a response message in response to receiving a request of acquiring the display-pending information from the client to facilitate the client to display the display-pending information in a lock screen interface of the mobile terminal device; or
pushing the display-pending information to the client of the mobile terminal device based on the correspondence relationship to facilitate the client to display the display-pending information in the lock screen interface of the mobile terminal device.

16. The one or more computer-readable media according to claim 14, the acts further comprising classifying the acquired display-pending information based on a category of the concerned application program.

17. An apparatus of providing application program information in a mobile terminal device, comprising:
a first operation entrance provision unit used for providing a first operation entrance for selecting a concerned application program to a user in a user interface;
a concerned application program determination unit used for determining the concerned application program based on a selection operation received via the first operation entrance, wherein the concerned application program includes one or more application programs;
a display-pending information acquisition unit used for obtaining information that is pending for display in the concerned application program; and
a lock screen interface display unit used for displaying the information that is pending for display in a lock screen interface of the mobile terminal device.

18. The apparatus according to claim 17, further comprising:
a first uploading unit, used for sending identity information of the concerned application program and identity information of the current mobile terminal device to a first server for storage after the concerned application program is determined based on the selection operation received via the first operation entrance, in order to facilitate the first server to acquire the display-pending information from a second server corresponding to the concerned application program based on the identity information of the concerned application program, and store a correspondence relationship between the display-pending information and the identity information of the mobile terminal device in the first server.

19. The apparatus according to claim 17, further comprising:
an account information acquisition unit used for acquiring account information of the user registered in a second server corresponding to the concerned application program; and
a second uploading unit used for uploading the account information to a first server for storage, so that the first server acquires the display-pending information from the second server corresponding to the concerned application program, based on identity information of the concerned application program and the account information of the user.

20. The apparatus according to claim 17, further comprising:
a details viewing request receiving unit used for receiving a request for viewing details of first display-pending information in the lock screen interface; and
an application program starting unit used for starting a first application program corresponding to the first display-pending information to facilitate displaying the details of the first display-pending information in the first application program.
